(19) United States
(12) Patent Application Publication
(10) Pub. No.: US 2011/0047700 A1
(43) Pub. Date: Mar. 3, 2011

(54) Longitudinal Drive for Patient Support Systems

(76) Inventors: Tobias Klemm, Saalfeld (DE); Ludwig Kreischer, Dormitz (DE); Christian Streitberger, Saalfeld (DE)

(21) Appl. No.: 12/860,186

(22) Filed: Aug. 20, 2010

(30) Foreign Application Priority Data
Aug. 25, 2009 (DE) 10 2009 038 785.4

(51) Int. Cl. A61G 13/02

(52) U.S. Cl. 5/600

(57) ABSTRACT

An optimized patient table arrangement for a medical examination device is described. The arrangement has a patient support table and a carrier arrangement on which the patient support table is movably arranged. The arrangement further has a movement device through which the patient support table is able to be moved relative to the medical examination device and a drive device through which the movement device is able to be driven. The movement device has two belts which are able to be meshed with one another in a zip and are able to be moved in parallel to one another along an essentially straight path. The belt elements each has belt drive engagement devices on one site that engage into drive engagement units of a drive wheel.

### CROSS REFERENCE TO RELATED APPLICATIONS

This application claims priority of Gelman application No. 10 2009 038 785.4 filed Aug. 25, 2009, which is incorporated by reference herein in its entirety.

### FIELD OF THE INVENTION

The invention relates to a patient table arrangement for a medical examination device.

### BACKGROUND OF THE INVENTION

During the examination of a patient in an imaging system such as a Computed Tomograph, Magnetic Resonance Tomograph or PET system, as a result of the restricted volume able to be recorded (Field Of View (FOV)) of the imaging system, an object under examination or a patient, depending on the region of the body to be investigated, has to be positioned differently in the imaging system.

As a rule in such cases a patient lying on an examination plate or an object under examination is moved a different distance into the imaging system. The necessary travel is then at its maximum when the patient has to be positioned in the FOV over the entire length of their body (whole body scanning). This means that the patient table carrying the patient or the object under investigation has to be moved into the imaging system far enough to enable an image of the head to be recorded, after which further regions of the body are recorded successively thereafter, down to the feet.

With the usual dimensions of FOV and length of an imaging system this type of examination (whole body imaging) results in a greater necessary movement path of the support plate from the start position (FIG. 1).

Frequently in such cases the necessary movement path is greater than the length of the patient table itself, which is essentially predetermined by the size the patient.

In these cases the transmission of the drive force necessary to move the patient cannot be applied directly to the support plate. A mechanism is to be used which transmits force between a drive motor and the patient table. During the examination this mechanism should have no influence or only a very slight influence on the quality of the examination result.

Particular technical difficulties emerge in the case of magnetic resonance tomography from the fact that the drive motor must either be magnetically compatible or must be accommodated sufficiently far away from the examination area. The support plate and the transmission mechanism should be embodied compatible with magnetic fields in such cases (i.e. completely non-magnetic where possible and generally non-conductive) and also be embodied not to appear in the image. In the event of imaging with ionizing radiation all parts of the plate and of the transmission system which enter the path of the beam should where possible only have a minimal effect on this radiation (e.g. x-ray or Gamma radiation).

In accordance with DE102004052265-A1 this problem was previously resolved by a transmission system coupling an MR-compatible motor to a patient support plate sufficiently far away from the imaging area of a magnetic resonance tomograph.

The disadvantage of this solution is that a comparatively high looseness (or play) between a table position (or a drive wheel on the patient support plate) and the motor shaft makes the drive control difficult and is expensive to compensate for. Where the position on the drive shaft is determined a positioning of the patient is also only possible with restricted accuracy. Because of the high demands on mechanical accuracy of the transmission and the necessary magnetic compatibility this solution is very expensive.

WO 03/037182 offers a solution in the form of a conveyor belt for a patient support table.

W09846903A describes a general principle of a conveyor belt without reference to medical examination systems.

### SUMMARY OF THE INVENTION

The object of the invention is to make an optimized movement of a patient support table possible. The relevant object is achieved by the subject matter of the independent claim. Advantageous embodiments emerge from the dependent claims.

The surface of the patient support table, on which surface an object under examination or patient is able to be positioned, can extend in accordance with the invention in parallel (and not at right angles) to a direction in which the belts or chains are able to be moved.

An inventive patient table arrangement or medical examination device patient table arrangement is especially able to be used in a medical examination device in the form of an MRT or a Computed Tomography device or a Positron Emission Tomography device.

A pull or push belt is also known from FR1136948A from the year 1955 which relates not to medical examination devices, but for lifting samples, with the surface of the support table, on which surface an object under examination is able to be positioned, extending at right angles to the direction in which the belts or chains are able to be moved.

### BRIEF DESCRIPTION OF THE DRAWINGS

Further possible features and advantages of embodiments of the invention emerge from the dependent claims and from the subsequent design of an exemplary embodiment which refers to the drawing. The figures show:

FIG. 1 a schematic diagram of the introduction of a patient or object under examination into the imaging area of an imaging system with a patient support table with a support plate,

FIG. 2 an overhead view of a patient support table and a movement device in the form of a pull-push belt system,

FIG. 3 a detailed diagram of the movement device in the form of a pull-push belt system with drive wheels and returns and

FIG. 4 meshing of the movement device in the form of a pull-push belt system with drive wheels and returns.

### DETAILED DESCRIPTION OF THE INVENTION

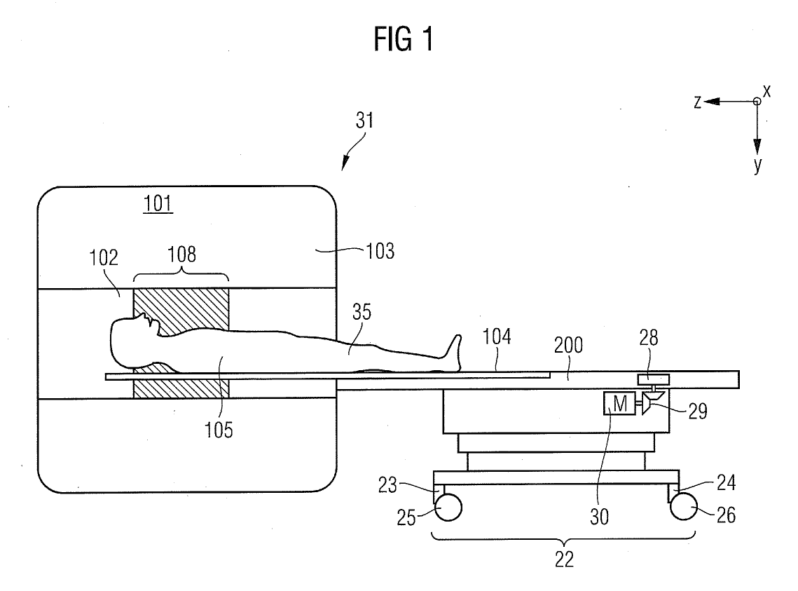

FIG. 1 shows a schematic diagram of a patient table arrangement 22 with a patient support table 104 of a Magnetic Resonance Tomography device 101 or other examination device which is arranged movably on the carrier arrangement 27 in and against the direction of the arrow z.

The carrier arrangement in this case contains a guide system for the support plate 104 as well as a movement device which is not shown in any greater detail here.

The carrier arrangement with the support plate can be moved in the vertical direction by a further drive system (which is not the subject matter of this application) when the table plate has been completely moved out of the magnets of the magnetic resonance tomography device 101.

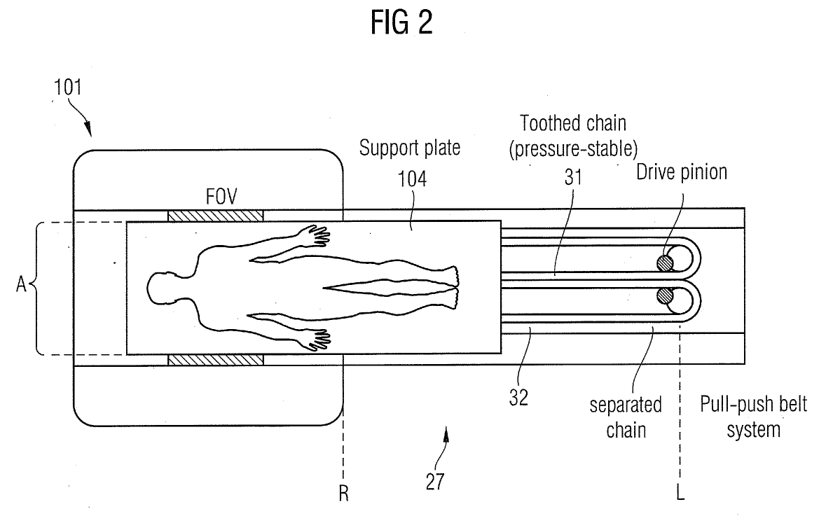

FIG. 2 shows a carrier arrangement 27 with an integrated movement device 200 comprising two belts 31, 32 each in the form of a chain, the teeth of which are meshed with each other in the left-hand area in FIG. 2 (to the left of the dashed line L) in the center of the support plate in the manner of a zip, while the teeth of the two belts 31, 32 in the right-hand area in FIG. 2 (to the right of the dashed line L) or on the outer side of the support plate are not meshed with each other in the manner of a zip (i.e. are separated from each other or are out of engagement).

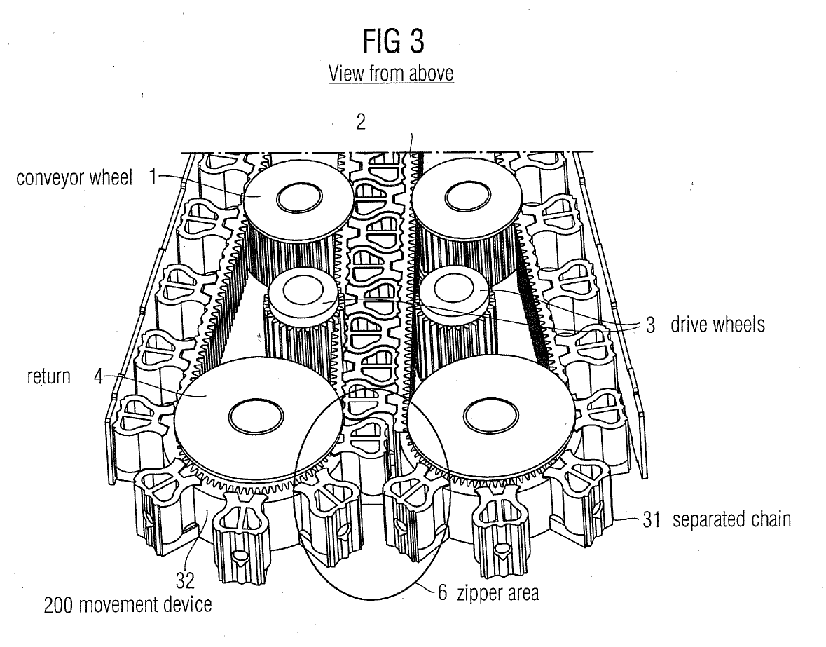

FIG. 3 shows a movement device 200 with the zip area in which the teeth (depending on the direction of movement of the belt in or against the direction z) of the two belts 31, 32 engage or disengage respectively.

The two belts or chains 31, 32 are movable in parallel along an essentially straight path (to the left of the line L) in parallel to one another.

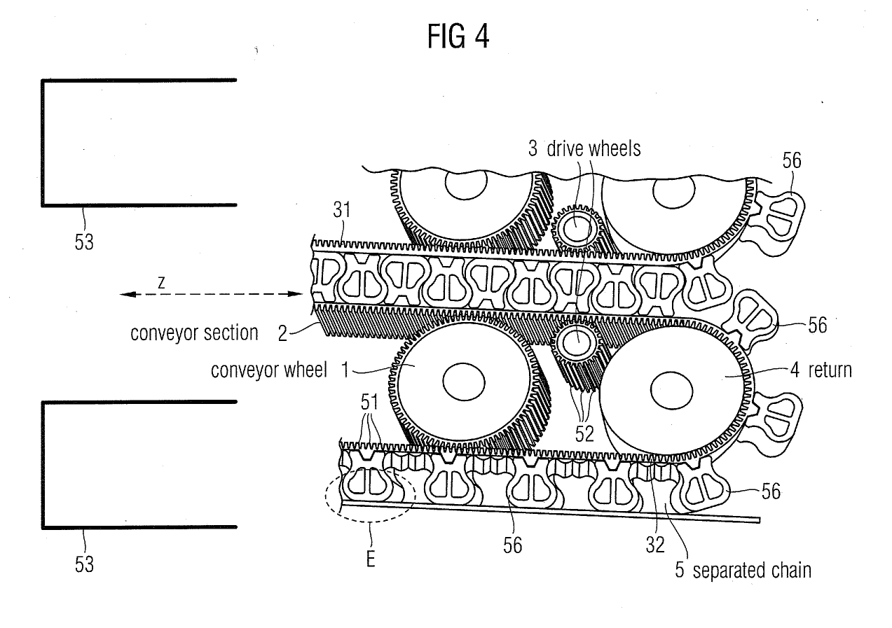

FIG. 4 shows that the belts 31, 32 (or chain elements in the case of belts in the form of the chain) each feature belt drive engagement devices 51 on a side facing the drive wheels 3 (here in the form of toothed wheels) of the drive device 28, 29, 30, which engage in the drive engagement devices 52 (here in the form of a plurality of teeth) of a drive wheel 3 of the drive. In addition return wheels 4 for redirecting the belts 5 (at the point which they are diverted by 180°) and conveyor wheels 1 for conveying or stabilization are provided.

The pull and push belt system of the movement device 200 consists of two flexible parts (the belts, especially chains) and can be combined by meshing in a zip-like manner into a tension and compression-proof rod-type arrangement which can transfer the drive force from a transmission engaging on an outer toothing to a patient support plate.

The maximum possible movement path is produced from the total length of the pull-push belt system.

In such cases it is also advantageous if, when the patient support plate is moved out of the gantry (the inside of the whole-body coil), the two parts of the belts are flexible and for example can be accommodated rolled-up in a schematically indicated store 53 in a very compact manner.

The pull and push belt system consists here of (essentially) completely non-magnetic or non-metallic plastic components. This means that it is very good for use in an MRT magnetic field and also in the field of view (FOV) of magnetic resonance tomographs and, because of its small interaction with ionizing radiation, also gives great advantages in the construction of imaging systems which operate with ionizing radiation.

In view of the forces to be transmitted, the proposed solution can also be manufactured easily and at low-cost. The option of easy construction and enabling the components of the chain to be easily stored makes this drive especially suitable for use in mobile patient support systems for which particular requirements are imposed on the low weight to be maneuvered.

The positioning can be undertaken with very little play or looseness since the two components of the chain engage without play.

The pull and push belt system is made of plastics here which make possible a lubrication-free and maintenance-free function over its entire lifetime.

A specific arrangement of drive wheels and guides or return rollers avoids irregularities which can arise in the meshing of the individual belts during the forward movement of the table plate or which can also arise during the separation of the individual belts during the backwards movement of the support table plate 104.

If the entire drive unit is matched geometrically precisely to the belt guides high transport speeds are also possible.

The drive unit can contain an additional arrangement which allows the table plate or the pull and push belt system to be mechanically separated from the drive or the motor. This makes manual movement of the table plate possible more easily in the event of an error, in that the remaining braking moment of the motor is uncoupled. This function can be provided if there is a power failure and the patient has to be manually removed from the imaging system.

Stops which restrict the maximum movement of the patient table plate can be realized by simple push-on parts which prevent further meshing of the belt system. By moving or latching these parts onto other parts of the zip a flexible option is provided for setting the possible movement length of the table plate.

The very simple and low-cost push-pull belt system allows almost any given movement lengths and is completely compatible with magnetic fields and also has very good compatibility with other imaging methods such as Computed Tomography and Positron Emission Tomography (especially a good attenuation and scatter behavior for x-ray and Gamma radiation).

An especial advantage in the integration into a drive system can be produced by the fact that
the toothed system is very rigid and represents an almost ideal push rod and
that the separate individual belts or bands are very flexible and therefore the necessary storage spaces can be designed very variably.

The reference signs in the claims only serve as examples and are not intended in any way to be a restriction on the area of protection.

1.-35. (canceled)

36. A patient table arrangement for a medical examination device, comprising:
a carrier device;
a patient support table that is movably arranged on the carrier device; and
a movement device that moves the patient support table relative to the medical examination device, the movement device comprising:
belt engagement devices,
two belts that are meshed together in a zip by the belt engagement devices and moved along an essentially straight path in parallel to one another,
a drive wheel comprising drive engagement devices, and
belt drive engagement devices arrange on one side of each of the belts that engage into the drive engagement devices.

37. The patient table arrangement as claimed in claim 36, wherein a surface of the patient support table extends in parallel to a direction in which the belts are moved.

38. The patient table arrangement as claimed in claim 36,
wherein the belts are chains and comprise chain links as belt elements, and
wherein the belt elements are meshed in a friction fit without play and/or resting against each other.

39. The patient table arrangement as claimed in claim 36, wherein the belt drive engagement devices and the drive engagement devices are teeth.

40. The patient table arrangement as claimed in claim 36, wherein the belt engagement devices are mounted on the belts and comprise elements manufactured separately from the belts.

41. The patient table arrangement as claimed in claim 36, wherein the belt engagement devices comprise an approximately trapezoidal cross-section in an area away from a connection point with the belts and a circle sector-shaped or arc-shaped cross section in an engagement area.

42. The patient table arrangement as claimed in claim 36, wherein the patient support table is able to be moved horizontally in a direction of the medical examination device and is able to be moved into the medical examination device.

43. The patient table arrangement as claimed in claim 36, wherein the movement device pulls and/or pushes the patient support table.

44. The patient table arrangement as claimed in claim 36, wherein the medical examination device is selected from the group consisting of: a Magnetic Resonance Tomography device, a Computed Tomography device, and a Positron Emission Tomography device.

45. The patient table arrangement as claimed in claim 36, wherein the carrier device is a carrier frame having a height of the patient support table and is able to be moved vertically.

46. The patient table arrangement as claimed in claim 36, wherein the patient table arrangement is a mobile system further comprising a trolley that removes the patient table arrangement from the medical examination device and moves out of an examination room.

47. The patient table arrangement as claimed in claim 36, wherein the patient table arrangement is a stationary unit.

48. The patient table arrangement as claimed in claim 36, further comprising a motor and a conveyor transmission unit connected to the motor,
wherein the conveyor transmission unit comprises an emergency unlocking device that separates the motor from the conveyor transmission unit in a force flow, and
wherein the movement device is driven by the motor and the conveyor transmission unit.

49. The patient table arrangement as claimed in claim 48, further comprising two stores that are spirals or cylinders, and wherein the belts are conveyed individually into each of the stores by conveyor rollers arranged within the conveyor transmission unit.

50. The patient table arrangement as claimed in claim 49, wherein the conveyor transmission unit and the stores are located in an area of a support structure of the patient support table or another area of the patient support table.

51. The patient table arrangement as claimed in claim 49, wherein the stores extend in parallel to a direction in which the patient support table is moved.

52. The patient table arrangement as claimed in claim 49, wherein one of the stores comprises a redirection device that runs in an opposite direction to another one of the stores and moves the patient support table, and wherein the belts are partly accommodated in the redirection device.

53. The patient table arrangement as claimed in claim 49, wherein the movement device, the belts, the conveyor transmission unit, or the stores comprise non-ferromagnetic components or plastic components.

54. The patient table arrangement as claimed in claim 36, wherein one of the belts or both of the belts are attached to the patient support table or to an element connected to the patient support table.

55. The patient table arrangement as claimed in claim 36, wherein no gearing is provided between the motor and the belts.
